(19) United States
(12) Patent Application Publication
(10) Pub. No.: US 2021/0123305 A1
(43) Pub. Date: Apr. 29, 2021

(54) Combined Bucket Drill and Soil Screen Apparatus and Method for Archaeological Excavations

(71) Applicants: Brian Lynn Fritz, New Castle, PA (US); Allen Carl Fritz, Stoystown, PA (US)

(72) Inventors: Brian Lynn Fritz, New Castle, PA (US); Allen Carl Fritz, Stoystown, PA (US)

(21) Appl. No.: 17/079,487

(22) Filed: Oct. 25, 2020

Related U.S. Application Data
(60) Provisional application No. 62/926,662, filed on Oct. 28, 2019.

(51) Int. Cl. E21B 7/02; E21B 7/00; B07B 1/22; B07B 1/00

(52) U.S. Cl. CPC E21B 7/027; B07B 1/005; B07B 1/22; E21B 7/003

(57) ABSTRACT

One embodiment of a bucket drill and soil screen apparatus consists of a mast (9) attached to a prime mover vehicle (7). A carriage (10) and hydraulic motor (12) slide vertically along the mast from which an attached kelly bar (14) and drilling bucket (15) are rotated and lowered into the ground. A kickout assembly (13) lifts drilling bucket (15) outward in an arc. Soil and cultural artifacts are transferred to a screen basket (20) by rotating open the drilling bucket through a latch and hinge. The screen basket is lifted to its screening position and rotated around a central axis to facilitate the passing of fine soil particles through the hardware cloth walls of the basket. Cultural artifacts retained in the screen basket are transferred to a fixed sorting screen (22) by rotating the screen basket to its dump position.

### CROSS-REFERENCE TO RELATED APPLICATIONS

This application claims the benefit of provisional patent application Ser. No. 62/926,662 by the present inventors, which is incorporated by reference.

### BACKGROUND—PRIOR ART

The following is a tabulation of some prior art that presently appears relevant:

### U.S. Patents

U.S. Patents

| Patent Number | Kind Code | Issue Date | Patentee |
|---|---|---|---|
| 8,615,906 | B2 | 2013 Dec. 31 | Matthias et al. |
| 6,533,048 | B2 | 2003 Mar. 27 | Groce et al. |
| 2,873,950 | A | 1959 Feb. 17 | Kandle |
| 0,928,965 | A | 1909 Jul. 27 | Hanna |
| 3,208,593 | A | 1965 Sep. 28 | Dietert |
| 5,301,813 | A | 1994 Apr. 12 | Schnittjer |

Foreign Patent Documents

| Foreign Doc. | Cntry | Kind | Publ. | |
|---|---|---|---|---|
| No. | Code | Code | Date | Patentee |
| 02946944 | CN | A1 | 2016 Oct. 28 | Pasch |
| 1640507 | EP | A1 | 2006 Mar. 29 | Reich |
| 2832438 | FR | A1 | 2004 Oct. 22 | Durmeyer et al. |

### Nonpatent Literature Documents

Fritz, Brian L, (2018), Where are the Stratified Paleoindian Sites? Pennsylvania Archaeologist 88(2):49-56.
PHMC, (2017), Guidelines for Archaeological Investigations in Pennsylvania. Harrisburg, Pa.: Pennsylvania Historical and Museum Commission.

We, Brian L. Fritz and Allen C. Fritz, have invented an apparatus and method for conducting archaeological surveys and test excavations using a combined bucket drill and soil screen.

An initial step in an archaeological survey is to determine if archaeological deposits are contained within the ground across a given survey area. The long-accepted and established method for finding archaeological deposits and sites is to manually dig or excavate a round or square hole using a spade shovel. These small diameter holes are called shovel test pits (STPs). Hole diameters or widths vary from 30 cm to 57 cm depending upon regulations established by each state or federal agency. STPs are dug at regular intervals across the survey area. An interval of 15 meters or 50 feet is commonly prescribed by regulatory agencies.

Soil is removed from the STP in 5 or 10 cm excavation levels and placed in a portable screen box that is designed to separate and remove cultural artifacts from the soil. A typical hole size for the hardware cloth within the screen box is 4 holes-per-inch, also known as ¼″ hardware cloth. If present, artifacts are collected, bagged, and inventoried from each excavation level within each STP. Cultural artifacts found within a test hole indicates the presence of an archaeological site. The horizontal boundary of an archaeological site can be determined by the presence or absence of cultural artifacts excavated from test holes that are spaced at regular intervals across the survey area. The vertical limits of archaeological deposits can be estimated by documenting the depths of excavation levels from which cultural artifacts are recovered.

Manual excavation of STPs is physically demanding and costly in time and labor. Manually excavated STPs vary in hole diameter or width, causing variations in the volume of soil that is sampled between STPs and reduced accuracy within the test results.

STPs are excavated to the lowest depth at which archaeological deposits can potentially occur. The potential depth of archaeological deposits is dependent upon the geological setting of the survey location. In locations where archaeological deposits are typically found at depths of less than one meter, STPs are manually excavated with spade shovels. As the hole becomes deeper, it is more difficult to maintain the proper hole diameter, resulting in the walls of the test pit sloping inward to a smaller diameter. Undersized STPs result in under sampling of the archaeological deposit at deeper levels, introducing a serious and undesirable bias within the sampling strategy (Fritz 2018). It is important to remember that linear changes in the diameter of a circle result in exponential changes in that circle's area and the volume of any cylinder formed by that circle.

A=πr²

V=Ah

Whereas, A equals the area of the circle, r equals the radius of the circle or ½ the diameter, h equals the height of a cylinder, and V equals the volume of the cylinder or the volume of the STP excavation level.

In Pennsylvania, guidelines for conducting archaeological surveys established by the Pennsylvania Historical and Museum Commission (PHMC 2017) require excavation of STPs with diameters of 57 cm. In a hypothetical STP, let us assume that the diameter of the STP is 57 cm at the ground surface, but due to the difficulty of excavating with a spade shovel, the walls of the STP slope inward to a diameter of 40 cm at a depth of 80 cm. Soil is removed in 10 cm levels. The volume of soil removed for each 10-cm level can be easily calculated for the two diameters. When comparing the results of these calculations it becomes apparent that the 30% reduction in STP diameter results in a 51% reduction in the volume of soil removed and screened. A 51% reduction in soil volume introduces a serious sampling bias that under samples archaeological deposits at depths of 80 to 100 cm.

The deepest archaeological deposits are buried along streams and rivers where soils have accumulated from multiple episodes of overbank flooding. Due to their small diameter, manually excavated STPs are inefficient for digging to depths of more than one meter. Because of this deficiency many regulatory agencies require the use of larger, manually excavated one-by-one-meter-square (1 m²) test pits to sample archaeological deposits that are more than one meter deep. In this type of excavation pit, workers enter the pit and perform the work from the floor of the pit.

Archaeological deposits that are more than one and one-half meters deep may require even larger test pits or installation of approved wall shoring to meet Office of Safety and Health Administration (OSHA) standards for worker safety due to the increased potential and danger of wall collapse. Therefore, the cost in labor and time for archaeological testing increases as the potential depth for archaeological deposits increases. In addition, excavating test pits deeper than one meter requires workers to enter the test pits, thus increasing the health and safety risks to workers resulting from falls, entrapment from collapsing excavation walls, and breathing air within confined spaces. Costly and sometimes dangerous manual excavation of archaeological test pits represents the predominant prior art in conducting archaeological surveys.

Mechanized soil augers, earth drills, hole diggers, earth boring machines, caisson drills, posthole augers, spiral augers, bucket augers, bucket drills, and similar machines are used in the construction industries to dig STP-sized holes. All employ a prime mover vehicle such as skid-steer loader, excavator, or drill rig from which a mechanism lowers a rotating auger and digging edge into the ground. Once filled with soil, the auger is lifted from the hole, and the soil is emptied from the auger. If the hole needs to be excavated deeper, then the auger is returned to the hole for the next extraction of soil. Earth drills and soil augers are constructed in three basic types, open flights that spiral around a central shaft, enclosed drilling buckets with cylindrical walls and a digging edge with inlet holes in its bottom plate, and a combination of spiral flights and enclosed bucket.

Augers with open spiral flights are unsuitable for archaeological applications because the open flights permit the mixing of soil and artifacts from multiple depths. Drilling buckets with closable inlet ports are better suited for archaeological applications because the enclosure encapsulates the excavated soil from a discrete layer and prevents mixing of soil from multiple depths. Digging edges located along inlet ports in the bottom plate lift soil into the drilling bucket as the bucket is rotated into the ground. Soil is emptied from the drilling bucket through a hinged bottom plate. Examples of drilling buckets are included in U.S. Pat. No. 2,873,950 (Kandle 1959), 6,533,048 (Groce et al. 2003), 8,615,906 (Matthias et al. 2013), and European Union patent 1,640,507 (Reich).

Swivel bottom drilling buckets allow the operator to close the inlet ports prior to lifting the bucket from the hole. When the bucket is rotated in the digging direction the bottom plate partially rotates to a position where the inlet holes are open. Once the bucket is filled, the operator rotates the bucket in the opposite direction and the bottom plate rotates to the closed position. Examples of augers with closable inlet ports include France patent 2,832,438 (Durmeyer et al. 204) and European Union patent 1,640,507 (Reich 2006).

Through my own trials and research, I have determined that these construction machines and methods are unsuitable for archaeological applications. They lack the capacity for precise depth control, and they lack the ability to extract and process discrete volumes of soil without mixing cultural artifacts from multiple excavation depths. None of these construction machines and methods combine the process of excavating soil from STP-sized holes with a process for screening the soil and collecting artifacts from discrete excavation levels. Rotary screens driven by prime movers have been proposed in U.S. patents 928,965 (Hanna 1909), 3,208,593 (Dietert 1965), and 5,301,813 (Schnittier 1994). However, such rotary screens have not been incorporated into a single apparatus for archaeological test pit excavation and soil screening.

One mechanized apparatus and method for excavation of archaeological test pits was proposed by Pasch in Canada patent application 2,946,944 (2016). The proposed apparatus employs an encased spiral soil auger that is rotated by a hydraulic drive motor. The wall of the auger casing contains a multitude of holes or openings of predetermined size. The apparatus is attached to a skid-steer loader which transports the apparatus between test locations and supplies power to the hydraulic motor. To excavate a test hole, the spiral auger is rotated as the skid-steer lowers the apparatus vertically into the ground. Once the desired excavation depth is reached, the apparatus is extracted from the test pit. Soil excavated from the test pit remains trapped in the flights of the auger and surrounding casing. The apparatus is then tilted to a horizontal position above the ground surface and rotated. While in a horizontal position, rotation of the auger allows soil to pass through holes within the auger casing resulting in the separation of artifacts from the smaller soil particles.

Through my own experiments and trials with mechanized soil augers and earth drills, I have identified a number of disadvantages in the apparatus and method proposed by Pasch (2016):

a. The method captures and extracts soil from the entire depth of the test pit resulting in the mixing of the soils and artifacts from all excavation levels. Most established archaeological testing strategies require the separation of soil and artifacts in regularly spaced intervals of depth or excavation levels.

b. Even if soil was captured and extracted from the test pit in excavation levels through multiple insertions and extractions, the lifting and lowering action of the skid-steer loader is not truly vertical but follows an arc. Due to this arc and the free hanging nature of the apparatus from the skid-steer loader, it is difficult to lower and raise the auger within the test pit without disturbing the walls of the test pit and causing soil and artifacts to fall from the walls into the bottom of the test pit. Mixing of soil and artifacts within the test pit is undesirable and causes less accurate test results.

c. With the soil auger directly suspended from the lift arms of a skid-steer loader, it is difficult to control and gage the depth of a soil auger as it enters the ground. Accurate control of excavation depth is necessary for accurate excavation levels.

d. The apparatus does not provide a mechanism to close the bottom of the auger and auger casing to prevent soil from falling out of the bottom of the apparatus when it is extracted from the test pit. Soil falling out of the auger and into the test pits again causes undesirable mixing of soil and artifacts from multiple excavation levels.

### Advantages

One or more aspects of our combined bucket drill and soil screen apparatus and method are superior to the established methods of manually excavating test pits because it:
Reduces manual labor
Reduces the time needed to complete archaeological test pits
Has increased vertical depth control
Excavates a circular hole with a consistent diameter from top to bottom
Can efficiently excavate small test pits to depths greater than one meter
Reduces the need for larger manually excavated pits within deep archaeological deposits
Reduces the safety hazards of placing workers in deep excavation pits
Reduces the need for expensive wall shoring in deep excavation pits

In addition, one or more aspects are superior to the apparatus and method proposed by Pasch in Canada patent application 2,946,944 (2016) because it:
Captures soil and artifacts in discrete excavation levels.
Can extract multiple excavation levels from the same test pit without mixing soil and artifacts from multiple levels.
Employs a hoist mechanism that lowers and lifts the drilling bucket in a linear motion as opposed to an arced motion.
Has increased vertical depth control.
Provides a method to close the inlet ports thus preventing soil from falling out of the bottom of the drilling bucket.
Can excavate test pits to depths greater than 1.2 meters.
Is more efficient due to discrete steps within a workflow that allows soil screening and pit excavation to occur simultaneously.

### Summary

In accordance with one embodiment, a bucket drill and soil screen apparatus is comprised of a drill mast attached to a prime mover vehicle. From the drill mast a drilling bucket with closable inlet ports is rotated and lowered into the ground for the excavation of an archaeological test pit. The bucket drill extracts soil from the test pit in discrete excavation levels. Soil is emptied from the drilling bucket through a hinged opening and transferred to a rotary screen basket with walls formed by hardware cloth. During rotation, fine soil particles within the screen basket pass through the hardware cloth until the fine soil particles have dissipated from the basket. Cultural artifacts larger than the openings within the hardware cloth are retained within the basket. The contents of the screen basket are emptied by rotating the basket upwardly and around through an arc to a position where the contents fall from the open end of the basket. The contents of the screen basket are transferred to a fixed box screen. Cultural artifacts are sorted and collected from the box screen. The process is repeated until the desired excavation depth is reached within the test pit.

### DRAWINGS—FIGURES

Included are three drawing sheets containing six figures. Component numbers are consistent across all six figures. Table 1 provides a list of components and associated numbers:

FIG. 1 is a perspective view showing the configuration of the apparatus during soil excavation.

FIG. 2. is a perspective view showing the configuration of the apparatus when dumping soil from the drilling bucket.

FIG. 3. is an elevation view showing the orientation of the screen basket when receiving soil from the drilling bucket.

FIG. 4. is an elevation view showing the orientation of the screen basket when rotating to remove fine soil particles.

FIG. 5. is an elevation view showing the orientation of the screen basket when transferring cultural artifacts into an unattached sorting screen.

FIG. 6. Is a perspective view detailing the kelly bar and slip clamp.

### DRAWINGS-LIST OF REFERENCE NUMERALS

7 Prime mover vehicle with auxiliary hydraulic circuit
8 Quick connector plate assembly
9 Drill mast
10 Carriage for drive motor
11 Hydraulic control valve
12 Drive motor
13 Drilling bucket kickout assembly
13a Kickout actuator
13b Kickout lever
14 Telescoping kelly bar assembly
14a Inner kelly bar shaft
14b Outer kelly bar tube
14c Linchpin
14d Slip retaining tabs
15 Drilling bucket
16 Lift arm spindle and hydraulic actuator
17 Lift arm
18 Screen basket spindle
19 Hydraulic motor for rotary screen basket
20 Screen basket
21 Handles for tipping the screen basket
22 Detached free-standing sorting screen
23 Kelly bar slip clamp
24 Excavated test pit

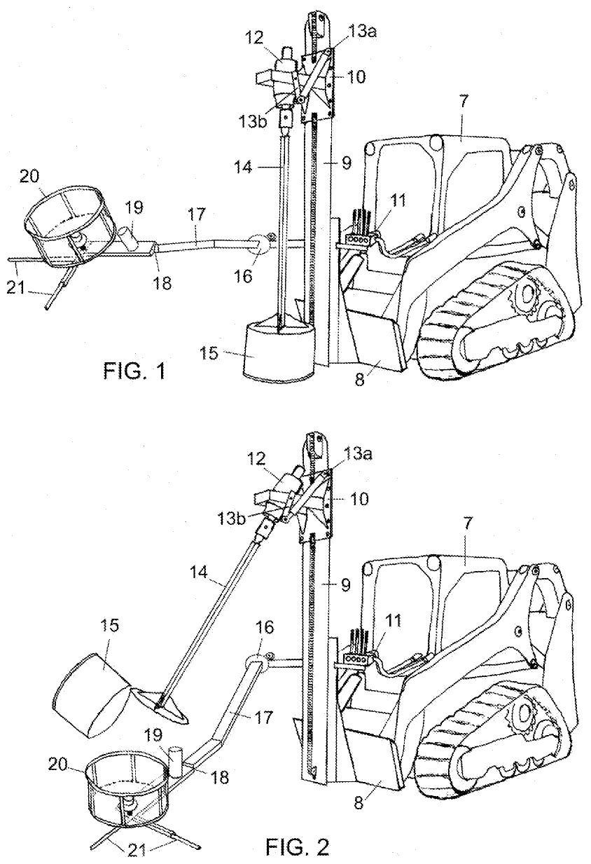

### DETAILED DESCRIPTION—FIRST EMBODIMENT—FIGS. 1-6

A skid steer track loader 7 with an auxiliary hydraulic circuit is used as a prime mover vehicle to move the apparatus between test pit locations and to power the hydraulic motors and actuators (FIG. 1). The apparatus consists of a drill mast 9 that is attached to track loader 7 through a quick connector plate assembly 8. This plate assembly 8 is fastened to the drill mast with fourteen bolts and can be adjusted up or down to accommodate differing heights in prime mover vehicles. A four-spool hydraulic control valve 11 is mounted to the right side of the drill mast 9. Hydraulic hoses with quick connectors supply hydraulic flow to the control valve 11 from the auxiliary hydraulic ports of the track loader 7.

A hydraulic motor 12 is mounted onto a carriage 10 with two pintles that allow the motor 12 to pivot within the carriage 10. A kickout mechanism consists of a hydraulic actuator 13a that connects to a lever 13b. The upper end of the lever 13b connects to the pintle of the drive motor 12 and the lower end of the lever 13b presses against the drive motor in a manner that permits the hydraulic actuator 13a to push or pivot the lower portion of the drive motor outward away from the drill mast 9. The carriage 10 is designed to slide up and down along the vertical extent of the drill mast 9. The carriage is suspended by a hoist mechanism that consists of roller chains and idler sprockets configured as a bi-directional gun tackle. The roller chains connect to the end of a hydraulic actuator mounted to the backside of the drill mast 9. Extension and contraction of the hydraulic actuator causes the carriage 10 to slide along the drill mast 9 a distance equal to twice the stroke length of the hydraulic actuator.

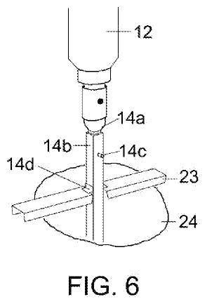

A square telescoping kelly bar assemblage 14 connects to the shaft of the drive motor 12 (FIGS. 2 and 6). The kelly bar assemblage 14 includes a solid inner kelly bar shaft 14a that slides into an outer kelly bar tube 14b. Welded to the end of the inner bar 14a is a hub that permits quick attachment to the hydraulic motor 12 with a linchpin. A linchpin 14c locks the position of the inner shaft 14a relative to the outer tube 14b. Two sets of linchpin holes in the inner shaft 14a allow the kelly bar assemblage 14 to be configured in a collapsed position or an extended position. Two flanges 14d welded to the outer tube 14b provide a footing for a kelly bar slip clamp 23. The slip clamp 23 slides around the kelly bar and under the flanges 14d. The slip clamp straddles the excavated hole to prevent the outer tube 14b from falling deeper into the hole when the linchpin 14c is removed. The bottom of the outer kelly bar tube 14b connects to a drilling bucket 15 with a linchpin.

The lid plate of the drilling bucket 15 connects to cylindrical walls of the drilling bucket through a hinge mechanism and a spring-loaded latch mechanism, each located at opposing positions along the upper rim of the bucket (FIG. 2). A manually triggered trip arm releases the spring-loaded latch mechanism allowing the bucket to open along a hinge at the top of the drilling bucket 15. The drilling bucket 15 has two bottom plates, one that is firmly attached to the circumference of the drilling bucket and the other that rests flush against the bottom of the fixed plate, but freely rotates approximately 90-degrees along a central spindle. Both plates have two matching openings or inlet ports that align when the drilling bucket 15 is rotated in a clockwise direction and closed when rotated in a counterclockwise direction. Two digging edges made from wear resistant steel are welded to the bottom plate along each opening. The digging edges project downward from the plate and are angled in a manner to direct soil upward through the inlet ports when the drilling bucket 15 is rotated in a clockwise direction.

A lift arm 17 connects to the drill mast 9 through a spindle 16 that is attached to a fixed arm that extends outward from the drill mast 9. A hydraulic actuator causes the lift arm 17 to rotate on the spindle 16 along an arc of approximately 90-degrees. A screen basket 20 connects to the lift arm 17 through a spindle 18. Two adjustable stops along the radius of the spindle 18 set the rotation limits. A hydraulic motor 19 mounts to the screen basket drive assembly. A roller chain contained within the rectangular drive assembly housing transmits power from the hydraulic motor 19 to the center axle of the screen basket 20. Two fixed handles 21 extend outward from the drive assembly. The handles 21 provide manual control over the drive assembly's rotation around the spindle 18.

The screen basket 20 rotates under hydraulic power along a central axle that is held in place by roller bearings located inside the drive assembly. The screen basket 20 connects to a four-bolt hub at the end of the axle. The screen basket 20 is constructed around a central hub from which radial ribs are welded and extend outward to the bottom ring of the basket. Corresponding vertical ribs are welded to the bottom ring and extend perpendicular to the upper ring of the basket. The rib and ring structure support four-holes-per-inch wire hardware cloth which form the bottom surface and the surface around the circumference of the basket. The upper or outward end of the screen basket 20 is open.

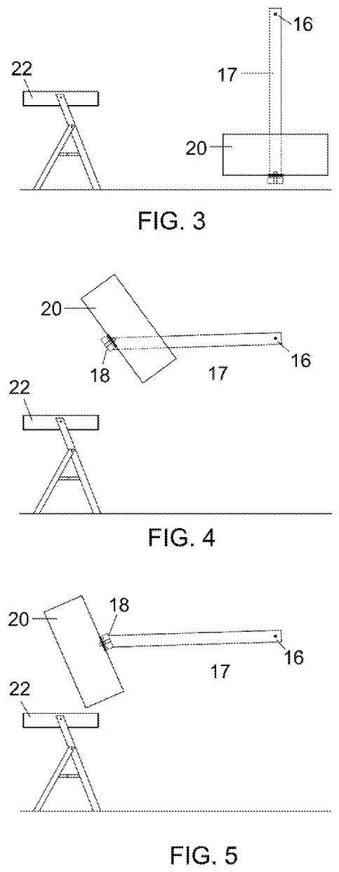

The hydraulic actuator connected to spindle 16 causes the lift arm 17 to rotate in an arc. When rotated to the bottom or low point of the arc, the screen basket 20 is positioned under the drilling bucket 15 when the drilling bucket is placed in its kicked-out position (FIG. 2). This vertical alignment permits the downward flow of soil from the open drilling bucket 15 to the screen basket 20 (FIG. 3). When the lift arm 17 is rotated upward and outward, the screen basket 20 rests at an angle that best facilitates the movement of fine soil particles through the hardware cloth as the screen basket revolves (FIG. 4). FIG. 5 shows the final position of the screen basket 20 after rotating or tipping the basket along the spindle 18. In this position, cultural artifacts and soil particles too big to pass through the hardware cloth fall from the screen basket 20 and into a detached free-standing sorting screen 22.

### Operation—First Embodiment

The bucket drill and soil screen method and apparatus achieve their result as follows. The track loader 7 is positioned to engage and attach to the drill mast 9 through the quick attachment plate 8 (FIG. 1). Hydraulic hoses connect the hydraulic control valve 11 to the auxiliary hydraulic ports on the track loader 7. The track loader 7 and attached apparatus are moved to the archaeological test hole location. The drill mast 9 is lowered to rest firmly on the ground surface and the track loader 7 is adjusted so that the mast is perpendicular to the ground surface. The carriage 10 is lowered until the drilling bucket 15 rests on the ground surface.

To begin excavation, the hydraulic motor 12 is engaged and rotated in a clockwise direction while the carriage 10 is slowly lowered. The rotating drilling bucket 15 cuts into the ground surface as soil is lifted into the drilling bucket by the digging edge. A graduated scale painted onto the front surface of the drill mast 9 serves as a depth gauge as the carriage 10 and drilling bucket are lowered. When the desired depth is reached, the hydraulic motor 12 is stopped and then briefly re-engaged in a counterclockwise direction. The counter rotation closes the bottom plate, thus trapping the excavated soil within the bucket. Carriage 10 is raised to its highest position which lifts the drilling bucket 15 out of the excavated hole.

Transfer of the excavated soil from the drilling bucket 15 to the screen basket 20 begins with engaging the lift arm spindle and actuator 16 so that the lift arm 17 and screen basket 20 move downward in an arc to their lowest position (FIGS. 2 and 3). Engaging the kickout actuator 13 rotates the hydraulic motor 12 around its pintles, thus lifting the kelly bar 14, and drilling bucket 15 outward and up along an arc to a position overlying the screen basket 20. A trip arm on the lid of the drilling bucket 20 is triggered to release the spring-loaded latch. The drilling bucket 15 is manually lifted on its hinge to a position where its contents fall out of the bucket and into the screen basket 20. When emptied, the drilling bucket 15 is rotated on its hinge until the spring-loaded latch secures the bucket in its closed position. The drilling bucket kickout actuator 13 is engaged and the hydraulic motor 12, kelly bar 14, and drilling bucket 15 return to their vertical drilling position.

The lift arm actuator at spindle 16 is engaged to elevate the lift arm 17 and screen basket 20 to its working position (FIG. 4). The hydraulic motor 19 is engaged and the screen basket 20 begins to rotate. The rotation of the screen basket 20 causes fine soil particles within the screen basket to fall through the hardware cloth. When the fine soil has dissipated from the screen basket 20, the two handles 21 attached to the drive assembly are used to manually rotate the screen basket 20 counterclockwise around the spindle 18, thus tipping the screen basket 20 toward the detached free-standing sorting screen 22 (FIG. 5). The contents of the screen basket 20 fall into the sorting screen 22. When the screen basket 20 is empty, it is returned to its working position and the hydraulic motor 19 is disengaged to stop the screen basket's rotation.

Artifacts retained on the sorting screen 22 are collected and placed in a bag with a tag that designates the test hole, excavation level, and depth from which the artifacts were extracted. Any material remaining on the sorting screen 22 is discarded. While the soil and artifacts are being screened and sorted, the drilling bucket 15 is lowered back into the test pit and soil from the next excavation level is captured and lifted out of the hole. This process is repeated until the desired excavation depth is attained within the test pit. The track loader and apparatus are then moved to the next test pit location. Completed test pits are backfilled manually with spade shovels or at the end of the day using the track loader with a standard dirt bucket attachment.

If the archaeological deposits within a test hole extend to a depth below the reach of the collapsed kelly bar assembly 14, then the kelly bar is extended to increase its vertical reach. This requires the additional steps of extending the kelly bar 14, capturing the soil in the next excavation level, and then collapsing the kelly bar 14 so that the drilling bucket 15 can be removed from the hole. The inner kelly bar 14a is extended by removing the linchpin 14c, lifting carriage 10 to the top of the drill mast 9, and re-installing the lynch pin 14c to lock the kelly bar 14 in its extended configuration. This process is reversed to collapse the kelly bar 14. A kelly bar slip clamp 23 is placed around the kelly bar 14 before the linchpin 14c is removed which prevents the outer kelly bar tube 14b and drilling bucket 15 from falling deeper into the test pit. To further increase the excavation depth, additional kelly bar extensions can be inserted between the expanded kelly bar assembly 14 and the hydraulic motor 12 as needed. This first embodiment can extract soil from depths up to 3 meters. Additional kelly bar extensions can be added to increase excavation depth to greater than 3 meters.

### Conclusion, Ramifications, and Scope

At least one embodiment of the combined bucket drill and soil screen provides an alternative method to the manual excavation of archaeological test pits while reducing costs in time and labor and improving worker safety. The above described embodiment reduces the problem of soil mixing between excavation layers, thus improving the separation and recovery of cultural artifacts from discrete excavation levels. My above description of a combined bucket drill and soil screen contains many specificities; however, these specificities should not be construed as limitations, but rather as an example of one embodiment. Many variants are possible.

There are several alternative embodiments in which the combined bucket drill and soil screen method can achieve the same results.
Alternatives to the skid steer track loader 7 power unit, include wheeled skid loaders, walk-behind skid loaders, stand-behind skid loaders, farm tractors, track loaders, wheeled loaders, remote controlled crawler tractors, hydraulic excavators, truck chassis, and trailer chassis.
The height of the drill mast and length of the kelly bar 14 can be varied for differing excavation depths and track loader 7 carrying capacities.
Alternatives for the hydraulic cylinder and roller chain gun tackle that actuate the vertical movement of the carriage 10 include a hydraulic cylinder and a wire rope gun tackle assembly or a configuration in which the carriage 10 and attached roller chain is actuated by a combination of sprockets and gears driven by a hydraulic motor.
The diameter and length of the drilling bucket 15 can be varied to accommodate test pit size requirements.
A drilling bucket 15 with a fixed lid plate and hinged bottom plate can be used to empty the drilling bucket through the bottom.
Alternatives to the bucket kickout mechanism 13 include various configurations of hydraulic cylinders and levers that push or pull the hydraulic motor and kelly bar outward to the drilling bucket dump position.
An alternative to the drilling bucket kickout mechanism 13 includes a mechanical kickout bar used to force the kelly bar and drilling bucket 15 to arc outward to its dump position when the carriage 10 is lowered. One end of the kickout bar connects to the top of the kelly bar 14 in a manner that allows the bar to pivot outward. The other end of the kickout bar inserts into a slot on the drill mast 9. Lowering the carriage 10 causes a downward force on the kickout bar. The geometry of the kickout bar relative to the drill mast 9 is configured so that the downward force is relieved by propelling the hydraulic motor 12 and kelly bar 14 outwards.
Differing lift arm 17 lengths, geometries, and actuator mechanisms can be used to move the screen basket 20 to its various working positions. In one variation the screen basket lift arm remains fixed at the spindle 16 and a washtub is place under the drilling bucket 15 when in its kickout position. Soil from the drilling bucket 15 is dumped into a wash tub. The washtub is then manually lifted over the opening in the screen basket 20 and the soil is emptied into the basket.
The diameter and depth of the screen basket 20 and the opening size of the hardware cloth can be varied to accommodate differing soil conditions and artifact collection policies.
Alternative screening systems can be used including varying geometries of rotating baskets, trommel screens, and flat screens that shake, oscillate, vibrate, or any combination of these movements.
Various tools mounted within the screen basket 20 may be designed to assist in breaking up soil clods and to force fine soil particles through the hardware cloth, including flights or baffles made of various materials that redistribute soil within the basket; rubber pads or flaps that push soil against the hardware cloth; or assemblies of shaft mounted rubber-fingered rollers and stars that rotate against the inner surfaces of the hardware cloth.
Instead of emptying the screen basket 20 directly into the free-standing sorting screen 22 (FIG. 5), a sheet metal baffle may be placed under the screen basket in a position that directs the coarse soil particles and artifacts into a bucket or tub. The bucket or tub is then manually lifted and emptied into the sorting screen located near the apparatus.

We claim:

1. A combined bucket drill and soil screen apparatus for excavating archaeological test pits, comprising:
a drill mast attached to a prime mover vehicle having a carriage and drive motor slidably attached to said drill mast, and a means for conveying energy from said drill mast to said carriage such that the drive motor can be controllably lifted and lowered;
a drilling bucket comprising a cylinder and a floor; and said floor having at least one digging edge and inlet port; and said inlet port having a selectable open position and closed position; and means for coupling rotational energy from said drive motor to said drilling bucket;
a soil screen mechanism attached to said drill mast having a drive actuator and a pivotally attached screen basket, wherein the walls of said screen basket having a multitude of openings of predetermined size; and means for coupling rotational energy from said drive actuator to said screen basket thereby causing soil particles to pass through said multitude of openings;
means for transferring soil from said drilling bucket to said screen basket;
means for transferring cultural artifacts retained within said screen basket to a detached sorting screen;
means for controllably coupling power from said prime mover vehicle to said motors and actuators;
whereby discrete volumes of soil are captured and extracted from an archaeological test pit at measured excavation depths and the extracted soil is screened to separate and collect cultural artifacts contained within the soil.

2. A method for excavating archaeological test pits and screening the extracted soil for the recovery and collection of cultural artifacts contained within the soil, comprising:
providing a drill mast attached to a prime mover vehicle having a carriage and drive motor slidably attached to said drill mast, and a means for conveying energy from said drill mast to said carriage such that the drive motor can be controllably lifted and lowered;
providing a drilling bucket comprising a cylinder and a bottom; and said bottom having at least one digging edge and inlet port; and said inlet port having a selectable open position and closed position; and means for coupling rotational energy from said drive motor to said drilling bucket;
providing a soil screen mechanism attached to said drill mast having a drive actuator and pivotally attached screen basket, wherein the walls of said screen basket having a multitude of openings of predetermined size; and means for coupling rotational energy from said drive actuator to said screen basket thereby causing soil particles to pass through said multitude of openings;
rotating and lowering said drilling bucket into the ground to a measured depth, thereby capturing a discrete volume of soil within said drilling bucket;
lifting said drilling bucket and captured soil from the excavated pit to a dump position;
opening and emptying said drilling bucket and transferring captured soil to said screen basket;
lifting said screen basket to an operating position
applying rotational energy to said screen basket thereby causing soil particles to pass through said multitude of openings;
transferring cultural artifacts retained in said screen basket to a detached sorting screen;
collecting cultural artifacts from said sorting screen;
repeating the above steps until the desired excavation depth is obtained within the excavated pit;
whereby discrete volumes of soil are systematically removed from the excavation pit at measured excavation depths and the extracted soil is screened to recover and collect cultural artifacts contained within the soil.
